(19) United States
(12) Patent Application Publication
(10) Pub. No.: US 2025/0332865 A1
(43) Pub. Date: Oct. 30, 2025

(54) RIGID AXLE COMPRISING AN AXLE CARRIER HAVING A CRANKED CONTINUOUS TUBULAR COMPONENT AND AN ELECTRICAL MACHINE MOUNTED THEREON

(71) Applicant: Jost-Werke Deutschland GmbH, Neu-Isenburg (DE)

(72) Inventors: Tobias Neutze, Calden (DE); Tom Backes, Kassel (DE)

(21) Appl. No.: 18/865,062

(22) PCT Filed: May 9, 2023
(86) PCT No.: PCT/EP2023/062290

§ 371 Date: Nov. 12, 2024

(30) Foreign Application Priority Data
May 13, 2022 (DE) 10 2022 112 096.1

(51) Int. Cl. B60B 35/08; B60B 35/06; B60G 9/00

(52) U.S. Cl. CPC B60B 35/08; B60B 35/06; B60G 9/003; B60G 2206/012; B60G 2206/312

(57) ABSTRACT

A rigid axle having an axle carrier, at each of the axial longitudinal end regions of which one wheel hub assembly is disposed, wherein: each wheel hub assembly has a rotatable wheel flange; the axle carrier is dropped in a drop region located between its longitudinal end regions; an electromechanical functional module having an electric energy converter machine is disposed in the drop region, which electric energy converter machine is connected to at least one wheel flange for transmitting a rotation, so that the energy converter machine can be used as at least one of the functional units stated hereinafter: i) as an electric drive unit for transmitting torque onto the at least one wheel flange, and ii) as an induction unit which can be operated as a generator for generating electric energy by transmitting torque from the at least one wheel flange to the energy converter machine; the axle carrier having a dropped tubular component which is continuous between its longitudinal end regions.

This Application claims priority in PCT application PCT/EP2023/062290 filed May 9, 2023, which claims priority in German Patent Application DE 10 2022 112 096.1 filed on May 13, 2022, which are incorporated by reference herein.

The present invention relates to a rigid axle for a motor vehicle, comprising an axle carrier, on each of the axial longitudinal end regions of which, their distance from each other defining an axial direction of the rigid axle, one wheel hub assembly is arranged, wherein each wheel hub assembly has a wheel flange that is rotatable relative to the axle carrier, wherein each wheel flange is designed for the non-rotatable fixation of a wheel on the wheel flange, wherein the axle carrier is dropped in a drop region located axially between its longitudinal end regions, wherein an electromechanical functional module with an electrical energy converter machine is arranged in the drop region, which is connected to at least one wheel flange for transmitting a rotary motion between the energy converter machine and the at least one wheel flange, so that the electrical energy converter machine can be used as at least one of the two functional units mentioned below:
i) as an electromotive drive unit for transmitting torque from the energy converter machine to the at least one wheel flange, and
ii) as a generator induction unit for generating electrical energy by transmitting torque from the at least one wheel flange to the energy converter machine.

### BACKGROUND OF THE INVENTION

Such a rigid axle is known from the company Valx International in Veghel (NL) under the product name “E2!HD”. The axle carrier of this known rigid axle is formed from three straight tubular sections, of which the two axially outer tubular sections, each carrying wheel hub assemblies, are arranged coaxially with a common tube axis and the middle tubular section, situated axially between the two axially outer tubular sections, is arranged with a tube axis that is parallel to the common tube axis of the axially outer tubular sections, but offset from it.

At each of its axial longitudinal ends, the middle tubular section is connected by a planar connecting plate to the respective longitudinal end, situated remotely from the wheel hub assembly, of another of the axially outer tubular sections. The two planar connecting plates are parallel to each other and orthogonal to the tube axes of the axially outer tubular section and of the middle tubular section.

The electrical energy converter machine of the known “E2!HD” axle is used as a generator for generating electrical energy for electrical consumers on the vehicle carrying the axle. On the known axle, only one of two wheel hub assemblies is connected in torque-transmitting fashion to the electrical energy converter machine, which operates only as a generator.

Such rigid axles, like the rigid axle of the present invention, are predominantly used as leading axles, that is, as an axle in front of the axle actually driven by a main drive of the respective vehicle, and/or as an axle of a trailing vehicle towed by a towing vehicle. Normally, such a rigid axle is part of a multi-axle rear-axle assembly of a vehicle.

A rigid axle having an electrical energy converter machine is known from the SAF-Holland company under the product name “SAF TRAKe”. When operated as a motor, the electric energy converter machine of this rigid axle is able to provide traction support and thus torque to the wheel flanges and to the wheels flanged to them and is able to decelerate the vehicle as an eddy-current brake during regenerative operation, thereby recuperating kinetic energy and storing it as electrical energy, or is able to generate electrical energy continuously and supply it to an electrical consumer, such as a cooling unit.

The known “SAF TRAKe” rigid axle has a split rectilinear tubular axle carrier having a differential gear arranged in its axial longitudinal center. A housing of the differential gear supports the electrical energy converter machine, whose armature shaft is kinematically coupled to the differential gear. Via the differential gear, the electrical energy converter machine is thus able to transmit a torque to the two wheel flanges or may be driven as a generator by the wheels flanged on the wheel flanges. The differential gear is thus integrated into the supporting structure of the known rigid axle.

While the electromechanical functional module of the Valx axle “E2!HD”, which operates as a generator, is not integrated into the supporting structure of the axle, the multi-part axle may have a lower load-bearing capacity than is possible within a given construction volume due to its numerous joints.

### SUMMARY OF THE INVENTION

The object of the present invention is to provide a robust rigid axle having a simple construction, a high load-bearing capacity, and the broadest possible use of an electrical energy converter machine.

The present invention achieves this object on a rigid axle of the type mentioned at the outset in that the axle carrier has a dropped tubular component which is continuous from one longitudinal end region to the other longitudinal end region.

By using a continuous, uninterrupted tubular component on the axle carrier, which preferably forms a main structural component of the axle carrier, the axle carrier can be designed with high rigidity and relatively low weight. Furthermore, in contrast to the known “E2!HD” axle, no axially overlapping tubular sections are required, which respectively extend into the solid connecting plates that connect them, and no solid connecting plates are required. This can also reduce weight.

By arranging the electromechanical functional module in the drop region of the axle carrier in the known manner, the electromechanical functional module can continue to be situated outside the flux of force of the chassis, to the formation of which the rigid axle contributes.

The continuous tubular component forms a main structural element of the axle carrier if it either represents at least 75% of the mass of the axle carrier, measured without electrical machines, or if it already ensures the function of the axle carrier on its own, for example because the wheel hub assembly can be attached on the tubular component and the tubular component can be supported as an axle carrier on the vehicle body via bearing means, such as link arms for example. At least one further auxiliary component, such as a bearing frame, a holder, an assembly and/or fastening formation and the like, may be arranged on the tubular component and connected to it in order to facilitate the assembly of the axle carrier on a vehicle body and/or to facilitate the arrangement of further components, such as the aforementioned at least one electrical energy converter machine, on the axle carrier. In such a case, the axle carrier is formed by the tubular component and the at least one auxiliary component arranged thereon.

The tubular component of the axle carrier is preferably made of one piece. In a less preferred specific embodiment, it may be made from multiple tubular components joined together, preferably by welding. The tubular component of the axle carrier is preferably produced in one piece from a formed blank. Thus, the tubular component of the axle carrier is preferably free of joints, which provides particularly high stability and strength. This absence of joints refers to the tubular component of the axle carrier as such. It does not preclude further components, such as the aforementioned at least one auxiliary component and the like, from being joined, in particular welded, to the tubular component of the axle carrier. Hence, the tubular component of the axle carrier is preferably free of joints, but not necessarily the axle carrier itself.

In principle, it shall not be excluded that a further component of the axle carrier connects axially to the tubular component. Preferably, however, each longitudinal end region of the tubular component is also a longitudinal end region of the axle carrier. Additionally or alternatively, it is preferred that the drop region of the axle carrier is also a drop region of the tubular component.

Since the rigid axle preferably forms a rolling axle of the vehicle carrying the axle, the longitudinal end regions of the axle carrier are preferably coaxial with regard to a common first extension axis on the axle carrier. The first extension axis is preferably likewise coaxial with wheel flange axes of rotation about which the two wheel flanges on the respective longitudinal end regions of the axle carrier are rotatable relative to the axle carrier.

The drop region then extends preferably along the first extension axis at a distance from it. The course of the drop region may follow a curved path, although it is preferable that the drop region has a straight section extending along a second extension axis parallel to the first extension axis and at a distance from it so as to facilitate the accommodation of the at least one electrical energy converter machine. The straight section has a rectilinear, uncurved course in the axial direction of the rigid axle.

The longitudinal end regions of the axle carrier and in particular of the tubular component are preferably also rectilinear and uncurved in their axial course.

To ensure the continuous tubular shape of the tubular component of the axle carrier, the axle carrier and in particular its tubular component preferably have a tubular connecting region between each longitudinal end region and the drop region, connecting the longitudinal end region with the drop region.

To increase the strength and stability of the axle carrier, the connecting region preferably extends obliquely, i.e., inclined at an angle of less than 90°, in particular of less than 70°, more preferably of less than 55°, with respect to the first extension axis. So as to be able to provide at the same time a drop region that is axially sufficiently long for arranging the at least one electromagnetic functional module, the connecting region extends also preferably inclined at an angle of more than 25°, in particular of more than 30°, more preferably of more than 35° with respect to the first extension axis.

Equally preferably, the continuous tubular component of the axle carrier is a planar component in the sense that the path which the continuous tubular component follows in its course between its longitudinal end regions is a planar path. This is the case, for example, if all axes of curvature of the tubular component are parallel to one another. Preferably, the tubular component is locally curved, preferably only locally curved, in the transition between the longitudinal end regions and the respectively adjoining connecting region as well as in the transition between the connecting regions and the drop region adjoining the connecting regions.

As was already explained above, in order to form a vehicle rolling axle on the vehicle carrying the rigid axle, the wheel flanges are arranged on the axle carrier so as to be rotatable about a common wheel flange axis of rotation. So as to increase its component rigidity and component strength, the tubular component of the axle carrier has at least one of the following features of continuous shape:
a) the tubular component extends along its path from longitudinal end region to longitudinal end region without kinking with respect to a kink axis oriented transversely to the wheel flange axis of rotation.
b) the tubular component extends along its path from longitudinal end region to longitudinal end region without any abrupt change in the shape and/or the size of its outer enveloping surface, and
c) the tubular component extends along its path from longitudinal end region to longitudinal end region without any abrupt change in the shape and/or the size of its inner enveloping surface.

The tubular component preferably comprises at least two of the three mentioned features, particularly preferably all three mentioned features. The tubular component is considered to be kinked if it is angled about a kink axis extending transversely, in particular orthogonally, to the wheel flange axis of rotation with a kink radius of less than 5 mm.

An abrupt change in the shape exists, for example, if the cross-sectional area occupied by the respective enveloping surface in a cross-section orthogonal to the path of the tubular component between its longitudinal end regions changes by more than 20% within a distance of less than 3 mm along the path of the tubular component, relative to the smaller of the two areas at the change section. An abrupt change in the shape also exists, for example, if the ratio of the height to the width of the cross-sectional area occupied by the respective enveloping surface in a cross-section orthogonal to the path of the tubular component between its longitudinal end regions changes by more than 20% within a distance of less than 3 mm along the path of the tubular component, relative to the smaller of the two ratios at the change section.

The features a) and/or b) and/or c) avoid unfavorable notch effects on the tubular component, which increases its strength and stability.

For transmitting torque between the wheel flange and the electromechanical functional module, the electromechanical functional module is preferably connected to the at least one wheel flange in torque-transmitting fashion by way of a drive shaft. With regard to the wheel flange axis of rotation, the drive shaft may be connected to the wheel flange in a non-rotatable manner and at its opposite end region may be connected in a non-rotatable manner to a rotatable part of the electromechanical functional module. A non-rotatable arrangement of a drive shaft on other rotatable components may be achieved by a spline-shaft profile, for example.

In order to be able to establish a torque-transmitting connection from the electromechanical functional module situated outside of the tubular component of the axle carrier to the wheel flange rotatably arranged on a longitudinal end region of the tubular component or axle carrier, the tubular component of the axle carrier preferably has a feed-through opening passing through the wall of the tubular component, through which the drive shaft extends. Although the feed-through opening represents a weakening of the structure of the tubular component, this weakening is still less than in the case of a tubular component completely separated into three parts, of which respectively two axially adjacent tubular components are arranged having tubular axes that are parallel but offset with respect to each other by more than the tubular diameter.

The feed-through opening is preferably formed in the aforementioned connecting region since this connecting region is preferably inclined with respect to the common first extension axis of the longitudinal end regions and thus facilitates a passage of a drive axle, which also preferably runs parallel to the first extension axis, through the feed-through opening.

For the purpose of connecting the rigid axle to a vehicle carrying the rigid axle, the rigid axle preferably comprises at least one link arm connected to the axle carrier and extending transversely, in particular orthogonally, to the axle carrier. Since the link arm reinforces the axle carrier or the tubular component at the location at which it is connected to the axle carrier, the feed-through opening is formed on the tubular component of the axle carrier in the region of the connection of the axle carrier to the link arm in order to avoid an unnecessary weakening of the axle carrier.

In principle, the link arm may be connected in any manner to the axle carrier. Preferably, the link arm is connected to the axle carrier in a clamping manner. In a concrete constructional embodiment, the link arm may be connected to the axle carrier by at least two fastening means arranged at a distance from one another in the axial direction of the rigid axle. The feed-through opening is then preferably formed between the two fastening means. Possible preferred clamping fastening means are brackets that are fastened on a component of link arm and axle carrier and embrace the respective other component of axle carrier and link arm.

Again preferably, the link arm is connected to the axle carrier in the region of the aforementioned connection region that connects a longitudinal end region of the tubular component or axle carrier to its drop region.

For the connection to a vehicle body, the rigid axle preferably has two link arms arranged at a distance from each other in the axial direction, each link arm being connected to the axle carrier. The link arms and their connection to the axle carrier are preferably designed to be identical or mirror-symmetrical relative to a mirror symmetry plane that is orthogonal to the path of the tubular component in the axial center in order to obtain, at both end regions of the rigid axle, identical axle reactions, such as force reactions and the like, to identical external influences in driving operation.

To prevent dirt and/or moisture from entering the tubular component through the feed-through opening, a cover component may be arranged on the tubular component of the axle carrier to cover the feed-through opening. In order nevertheless to allow the drive shaft to pass through the wall of the tubular component, the cover component may have a passage opening collinear with the feed-through opening and preferably at an axial distance from the feed-through opening, through which the drive shaft extends. The cross-sectional area of the passage opening preferably extends inclined in an angular range of 75° to 105° relative to the extension direction of the drive shaft, particularly preferably orthogonally to the extension direction of the drive shaft. This facilitates the arrangement of a shaft seal on the edge region of the cover component bounding the passage opening radially outwards. Even without the arrangement of a shaft seal, however, a passage opening inclined in this way impedes the ingress of dirt and liquid into the tubular component, particularly if the passage opening is arranged axially at a distance from the feed-through opening.

The tubular component of the axle carrier is preferably made of steel. The cover component may be made of a different material than the material of the tubular component, for example of a plastic, which may be formed particularly easily even in complex shapes, for example by casting or injection molding.

In general, the electrical energy converter machine may be directly connected in torque-transmitting fashion to the wheel flange by way of the drive shaft. The electrical energy converter machine then forms the electromechanical functional module. For adapting the input or output operating parameters of the electrical energy converter machine, depending on whether it is operated as a generator or as a motor, to the operating parameters of the at least one wheel flange specified by the driving mode, the electromechanical functional module may preferably comprise a gear unit. The input side of the gear unit is then coupled in torque-transmitting fashion to the electrical energy converter machine and is coupled on the output side in torque-transmitting fashion to the at least one wheel flange.

In principle, the gear unit may be of any construction type. Preferably, the gear unit is a planetary gear unit, which allows for very high transmission ratios in a very compact installation space and without axial offset. Although the planetary gear unit may be multi-stage, a single-stage planetary gear unit preferably suffices.

The electrical energy converter machine is preferably a synchronous electric machine that can be operated both as a motor and as a generator.

In order to avoid a resulting yaw moment acting on the rigid axle when only one electromechanical functional module is used, which only interacts with one of two wheel flanges of the axle carrier, a separate electromechanical functional module with its own electrical energy converter machine is preferably arranged in the drop region for each wheel flange of wheel hub assemblies arranged at different longitudinal end regions of the rigid axle. What is said above or below about the electromechanical functional module also applies to the further electromechanical functional module with regard to its advantageous development and the advantageous development of its interaction with and its arrangement on the axle carrier and/or the wheel flange connected to it in torque-transmitting fashion.

Each electrical energy converter machine is then connected to a wheel flange of another wheel hub assembly for transmitting a rotary motion between the energy converter machine and the respective wheel flange.

Each of the electrical energy converter machines is preferably capable of being operated independently of the operating state of the respective other electrical energy converter machine. This makes it possible to dispense with the use of a differential gear that distributes the torque of a drive to the two wheel flanges of an axle.

The rigid axle may comprise a control unit or may be connected to a control unit in the vehicle carrying the rigid axle. The control unit is designed to control the at least one electromechanical functional module, in particular its electrical energy converter machine in operation. Thus, the control unit is able to switch an electrical energy converter machine cooperating with it between motor and generator operation, and in motor operation is able to set the output power and/or the output speed of the electrical energy converter machine. The rigid axle, in particular the at least one electromechanical functional module, even more preferably its electrical energy converter machine, may comprise an electrical coupling formation, such as a plug and/or a socket, by which it is possible to establish the connection to a control unit on the side of the vehicle.

If the electrical energy converter machine is also capable of being operated as a generator, the rigid axle or the vehicle carrying it may comprise an electrical energy store connected to the electrical energy converter machine in electrical current-transmitting fashion. In generator operation, the electrical energy converter machine is able to store the generated electrical energy in this electrical energy store. For transmitting electrical current towards the at least one electrical energy converter machine or away from it, the rigid axle, in particular the at least one electromechanical functional module, particularly preferably the at least one electrical energy converter machine, may comprise a further coupling formation such as a plug and/or a socket.

To provide a rigid axle acting symmetrically in terms of driving dynamics, the axle body is preferably designed in mirror symmetry relative to its axial center.

Additionally or alternatively, for the use of identical parts, it may be provided that one electromechanical functional module is transferable into the other electromechanical functional module by rotating it through 180° about an axis of symmetry orthogonal to the axial direction of the rigid axle and by translational displacement. Thus, when using two electromechanical functional modules, these are preferably identical.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 a schematic perspective view of a specific embodiment according to the invention of a rigid axle of the present application,

FIG. 2 the rigid axle from FIG. 1 when viewed along the roll axis of a vehicle carrying the rigid axle,

FIG. 3 the rigid axle from FIGS. 1 and 2 when viewed along the yaw axis of a vehicle carrying the rigid axle, and

FIG. 4 a schematic sectional view of the left side of the rigid axle from FIG. 2 in a sectional axis orthogonal to the roll axis and containing the wheel flange axes of rotation.

### DESCRIPTION OF PREFERRED EMBODIMENTS

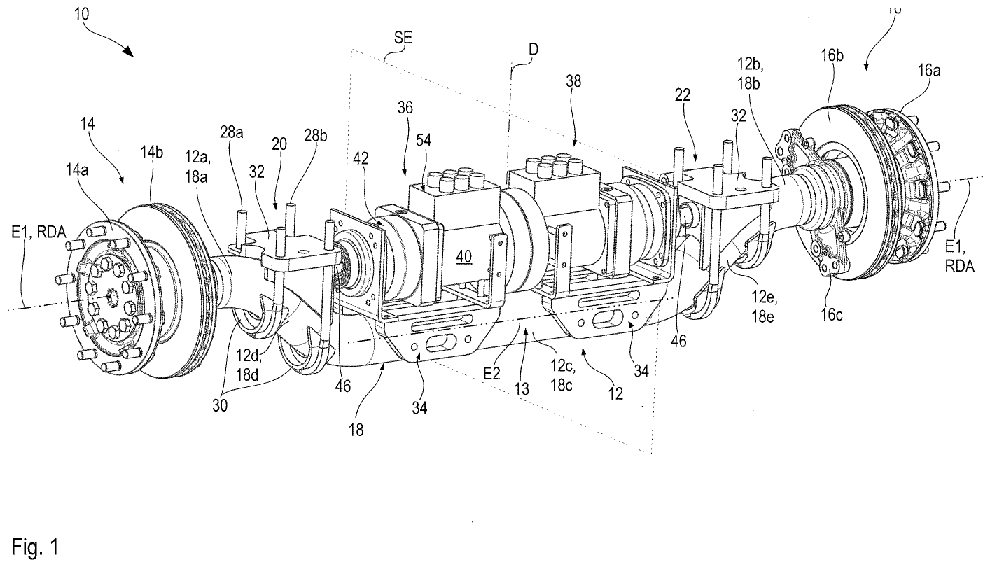

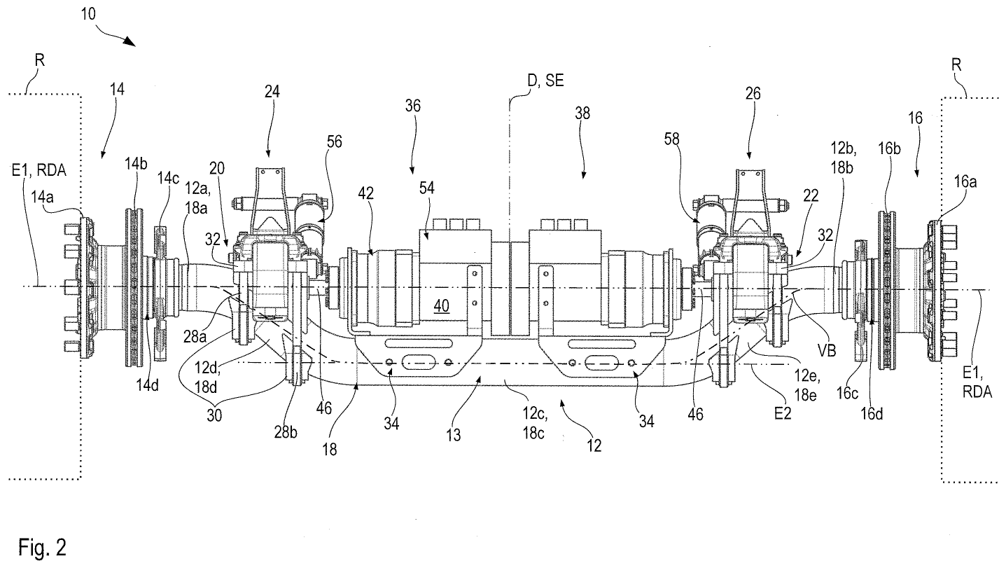

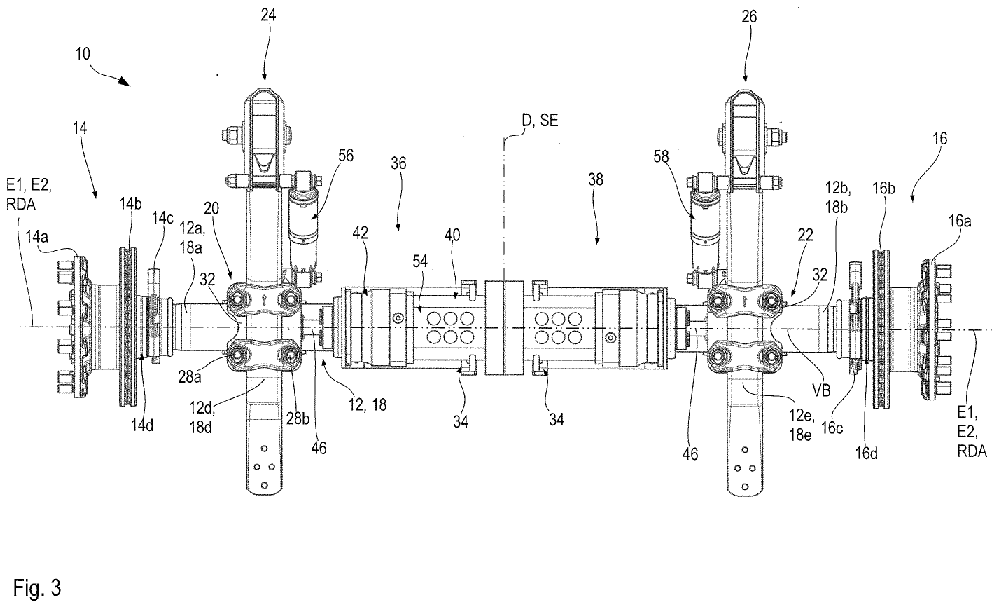

Referring now to the drawings wherein the showings are for the purpose of illustrating preferred and alternative embodiments of the invention only and not for the purpose of limiting the same, a specific embodiment according to the invention of a rigid axle of the present application is shown schematically in FIGS. 1, 2 and 3 and is denoted by reference numeral 10. FIG. 1 shows the rigid axle 10 in a perspective view, FIG. 2 in a front view and FIG. 3 in a top view. The view of FIG. 2 corresponds to a view along a roll axis of a vehicle carrying the rigid axle 10 in an operationally ready state. The view of FIG. 3 corresponds to a view along a yaw axis of a vehicle carrying the rigid axle 10 in an operationally ready state.

The rigid axle 10 comprises an axle carrier 12, on the longitudinal end regions 12a and 12b of which one wheel hub assembly 14 and 16 is respectively arranged.

The axle carrier 12 comprises a dropped tubular component 18, which extends continuously as one monolithic piece from one longitudinal end region 12a to the other longitudinal end region 12b of the axle carrier 12. Longitudinal end regions 12a and 12b of the axle carrier 12 are also longitudinal end regions 18a and 18b of the tubular component 18.

The longitudinal end regions 12a and 12b of the axle carrier 12 are coaxial with respect to a common first extension axis E1, which defines an axial direction of the rigid axle 10, in which the longitudinal end regions 12a and 12b of the axle carrier 12 are arranged at a distance from each other. Axially between the two longitudinal end regions 12a and 12b, the axle carrier 12 has a drop region 12c, which extends at a distance from the first extension axis E1.

In the present example, the drop region 12c is formed as a straight section 13, which extends along a second extension axis E2 extending parallel to but at a distance from the first extension axis E1. The drop region 12c of the axle carrier 12 is connected to the longitudinal end region 12a by a connecting region 12d and to the longitudinal end region 12b by a connecting region 12e.

The mentioned regions: drop region 12c and connecting regions 12d and 12e of the axle carrier 12 are also regions: drop region 18c and connecting regions 18d and 18e of the tubular component 18.

In the illustrated exemplary embodiment, the axle carrier 12 and the wheel hub assemblies 14 and 16 are designed in mirror symmetry with respect to a mirror symmetry plane SE that is orthogonal to the first extension axis E1, which is why it suffices to describe features of the axle carrier 12 and of the wheel hub assembly 14 or 16 in only one axial half of the rigid axle 10, since on the mentioned mirror symmetry condition their description also applies to the respective other axial half of the rigid axle 10.

The wheel hub assemblies 14 and 16 each have a wheel flange 14a and 16a, respectively, which are rotatable relative to the axle carrier 12 about a common wheel flange axis of rotation RDA that is coaxial to the first extension axis E1. Together with each wheel flange 14a and 16a, a respective brake disk 14b and 16b is rotatable about the common wheel flange axis of rotation RDA. Brake caliper brackets 14c (see FIGS. 2, 3 and 4) and 16c, which are fixed to the axle carrier, allow for brake calipers (not shown in the figures) to be arranged fixed to the axle carrier in order to be able to brake, in a manner known per se, the wheel flanges 14a and 16a associated with the respective brake disks 14b and 16b. The wheel hub assemblies 14 and 16 furthermore have roller bearings 14b and 16d, respectively, by which the wheel flanges 14a and 16a and the respective brake disks 14b and 16b are accommodated on the tubular component 18 or axle carrier 12 so as to be rotatable about the common wheel flange axis of rotation RDA.

In place of the disk brakes, the illustrated rigid axle 10 could also be equipped with drum brakes.

In the connecting regions 12d and 12e, mounting devices 20 and 22 are respectively provided for connecting the axle carrier 12 to a link arm 24 and 26 shown in FIGS. 2 and 3. The mounting devices 20 and 22 satisfy the mirror symmetry condition with respect to the plane SE described above.

The mounting device 20 comprises a short U-bolt 28a and a long U-bolt 28b as fastening means, which embrace the tubular component 18 and thus the axle body 12 in the connecting regions 18d and 12d by the respective interposition of a shell component 30. The straight shanks of the U-bolts 28a and 28b penetrate and thereby fixate a cover component 32, which rests on the connecting region 18d. The mounting devices 20 and 22 thus fixate the axle carrier 12 in clamping fashion on the respective link arms 24 and 26.

In the drop region 12c, the axle carrier 12 comprises two substantially identical brackets 34 which are, however, rotated relative to each other by 180° about an axis of rotation D intersecting both the first extension axis E1 and the second extension axis E2, each bracket 34 supporting an electromechanical functional module 36 and 38, respectively.

The brackets 34 are brackets made from bent metal parts, which are connected, preferably screwed or welded, to the tubular component 18 in the drop region 18c of the tubular component 18.

In the illustrated exemplary embodiment, the electromechanical functional modules 36 and 38 are identical and are merely arranged rotated relative to each other by 180° about the axis of rotation D. It therefore suffices to describe one of the electromechanical functional modules as this description also applies to the respective other electromechanical functional module on the mentioned arrangement condition.

The axis of rotation D runs parallel to the yaw axis of the vehicle when the rigid axle 10 is installed ready-to-operate on a vehicle.

The electromechanical functional module 36 comprises an electrical energy converter machine 40, in the illustrated example a rotary synchronous motor which, due to its permanent magnet-excited rotor, may be operated not only as a motor but also as a generator for recuperating kinetic energy or generally for generating electrical energy.

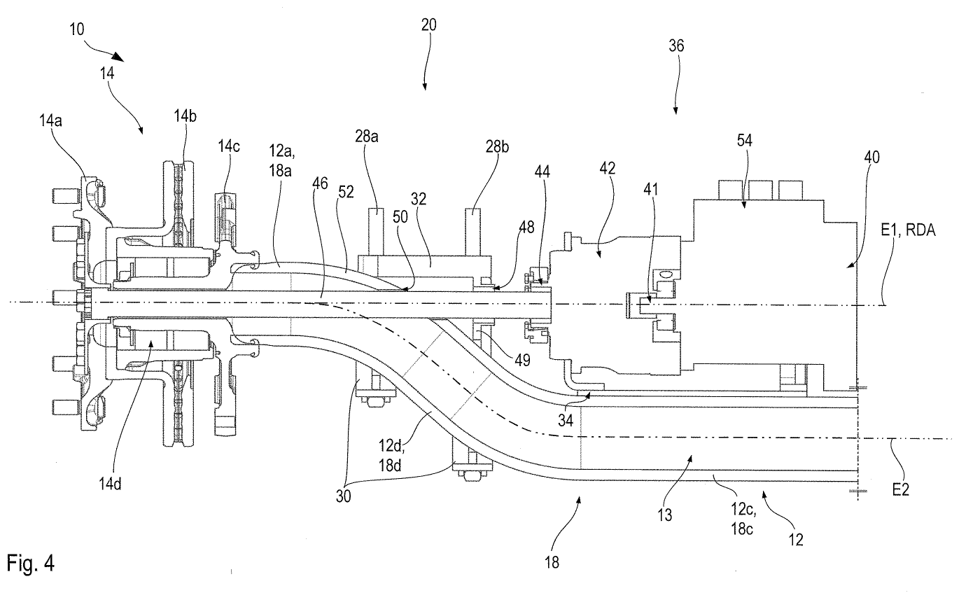

The rotor 41 of the electrical energy converter machine 40, which is only indicated in FIG. 4, is connected in torque-transmitting fashion on the side of the electrical energy converter machine 40 facing the axially closer wheel hub assembly 14 to a gear unit, in the illustrated exemplary embodiment a planetary gear unit. A connecting element 44 (see FIG. 4) of the gear unit 42, which is functionally opposite to the connection with the rotor 41 is coupled to the wheel flange 14a by way of a drive shaft 46 in a non-rotatable, that is, torque-transmitting manner.

As can be seen particularly clearly in FIG. 4, the drive shaft 46 extends coaxially to the wheel flange axis RDA. The drive shaft 46 extends through a passage opening 48 in a lateral wall 49 of the cover component 32 that is orthogonal to the wheel flange axis of rotation RDA or to the first extension axis E1 and extends further through a feed-through opening 50 in the wall 52 of the tubular component 18. After passing through the feed-through opening 50, the drive shaft 46 extends in the interior of the tubular component 18 until it reaches the wheel flange 14a, which is non-rotatably coupled to it. The feed-through opening 50 is covered by cover component 32 so as to impede the ingress of dirt and liquid through the feed-through opening 50 into the tubular component 18.

The feed-through opening 50 is situated axially between the two U-bolts 28a and 28b of the respective mounting devices 20 and 22. Thus, the unavoidable weakening of the tubular component 18 caused by the feed-through opening 50 can be at least partially compensated for by the mounting devices 20 and 22 and the link arms 24 and 26 bridging their respective U-bolts 28a and 28b.

The electromechanical functional module 36 may thus be used as a motor to drive the wheel flange 14a to rotate or as a generator it may be driven by a wheel R (indicated by a dotted line in FIG. 2) flanged to the wheel flange 14a to rotate and generate electricity.

The functional module 36 further comprises a control unit 54 for controlling the operation of the electrical energy converter machine 40. It may be coupled to a control unit of the vehicle carrying the rigid axle 10, for example via a CAN bus or a LIN bus.

FIGS. 2 and 3, which supplement the above explanation, show the link arms 24 and 26 as longitudinal link arms, which are connected to the axle carrier 12 respectively via one hydraulic shock absorber 56 and 58 in a manner known per se for damping relative movements between the link arms 24 and 26 and the axle carrier 12.

FIGS. 2, 3 and 4 show, in addition to the extension axes E1 and E2, the curvilinear path VB along which the tubular component 18 runs between its longitudinal end regions 18a and 18b. It can be seen particularly in FIG. 3 that the path VB lies in the plane spanned by the extension axes E1 and E2 so that the path VB is a planar path and that consequently the tubular component 18 is a planar tubular component. In the longitudinal end regions 12a or 18a and 12b or 18b as well as in the drop region 12c or 18c, the path VB coincides with the first extension axis E1 and the second extension axis E2.

As can be seen particularly in FIG. 4, the tubular component 18 extends, both in terms of shape and in terms of size, with a substantially constant tubular cross section from one longitudinal end region 12a or 18a to the opposite longitudinal end region 12b or 18b. The tubular component 18 extends along its path VB free of kinks and is curved only in the transitions between the longitudinal end region 12a or 18a and the connecting region 12d or 18d, between the longitudinal end region 12b or 18b and the connecting region 12e or 18e, between the connecting region 12d or 18d and the drop region 12c or 18c, and between the drop region 12c and the connecting region 12e or 18e, all axes of curvature of the mentioned curved regions being parallel to one another and orthogonal for example to the drawing plane of FIG. 2. This avoids unwanted notch effects on the tubular component 18 and thus on the axle carrier 12 and increases its strength and thus also its operational life.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-14. (canceled)

15. A rigid axle for a motor vehicle, comprising an axle carrier, on each of the axial longitudinal end regions of which, their distance from each other defining an axial direction of the rigid axle, one wheel hub assembly is arranged, wherein each wheel hub assembly has a wheel flange that is rotatable relative to the axle carrier, wherein each wheel flange is designed for the non-rotatable fixation of a wheel on the wheel flange, wherein the axle carrier is dropped in a drop region located axially between its longitudinal end regions, wherein at least one electromechanical functional module with at least one electrical energy converter machine is arranged in the drop region, which is connected to at least one wheel flange for transmitting a rotary motion between the energy converter machine and the at least one wheel flange, so that the electrical energy converter machine can be used as at least one of the two functional units mentioned below:
i) as an electromotive drive unit for transmitting torque from the energy converter machine to the at least one wheel flange, and
ii) as a generator induction unit for generating electrical energy by transmitting torque from the at least one wheel flange to the energy converter machine,
wherein the axle carrier has a dropped tubular component, which is continuous from its one longitudinal end region to its other longitudinal end region.

16. The rigid axle as recited in claim 15, wherein the longitudinal end regions of the tubular component are also the longitudinal end regions of the axle carrier and/or that the drop region of the axle carrier is a drop region of the tubular component.

17. The rigid axle as recited in claim 16, wherein the longitudinal end regions of the axle carrier are coaxial with respect to a common first extension axis on the axle carrier, wherein the drop region extends along the first extension axis at a distance from it, and wherein between each longitudinal end region and the drop region the axle carrier has respectively one tubular connecting region connecting the longitudinal end region with the drop region.

18. The rigid axle as recited in claim 15, wherein the longitudinal end regions of the axle carrier are coaxial with respect to a common first extension axis on the axle carrier, wherein the drop region extends along the first extension axis at a distance from it, and wherein between each longitudinal end region and the drop region the axle carrier has respectively one tubular connecting region connecting the longitudinal end region with the drop region.

19. The rigid axle as recited in claim 18, wherein the drop region has a straight section extending along a second extension axis parallel to the first extension axis and at a distance from it.

20. The rigid axle as recited in claim 15, wherein the wheel flanges are arranged on the axle carrier so as to be rotatable about a common wheel flange axis of rotation, wherein the tubular component of the axle carrier has at least one of the following features of continuous shape:
a) the tubular component extends along its path from longitudinal end region to longitudinal end region without kinking with respect to a kink axis oriented transversely to the wheel flange axis of rotation,
b) the tubular component extends along its path from longitudinal end region to longitudinal end region without any abrupt change in the shape and/or the size of its outer enveloping surface, and
c) the tubular component extends along its path from longitudinal end region to longitudinal end region without any abrupt change in the shape and/or the size of its inner enveloping surface.

21. The rigid axle as recited in claim 15, wherein the electrical functional module is connected in torque-transmitting fashion to the at least one wheel flange by way of a drive shaft, wherein the tubular component of the axle carrier has a feed-through opening passing through the wall of the tubular component, through which the drive shaft extends.

22. The rigid axle as recited in claim 21, wherein the rigid axle has a link arm connected to the axle carrier and extending transversely to the axle carrier, wherein the feed-through opening is formed on the tubular component of the axle carrier in the region of the connection of the axle carrier with the link arm.

23. The rigid axle as recited in claim 22, wherein the link arm is connected to the axle carrier by at least two fastening means arranged in the axial direction of the rigid axle at a distance from one another, wherein the feed-through opening is formed between the two fastening means.

24. The rigid axle as recited in claim 23, wherein a cover component is arranged on the tubular component of the axle carrier, wherein the cover component covers the feed-through opening and at an axial distance from the feed-through opening has a passage opening that is collinear with the feed-through opening, wherein the drive shaft also extends through the passage opening.

25. The rigid axle as recited in claim 21, wherein a cover component is arranged on the tubular component of the axle carrier, wherein the cover component covers the feed-through opening and at an axial distance from the feed-through opening has a passage opening that is collinear with the feed-through opening, wherein the drive shaft also extends through the passage opening.

26. The rigid axle as recited in claim 22, wherein a cover component is arranged on the tubular component of the axle carrier, wherein the cover component covers the feed-through opening and at an axial distance from the feed-through opening has a passage opening that is collinear with the feed-through opening, wherein the drive shaft also extends through the passage opening.

27. The rigid axle as recited in claim 15, wherein the electromechanical functional module comprises a gear unit, which is coupled on the input side in torque-transmitting fashion to the electrical energy converter machine and on the output side is coupled in torque-transmitting fashion to the at least one wheel flange.

28. The rigid axle as recited in claim 15, wherein for each wheel flange of the wheel hub assemblies arranged in different longitudinal end regions of the axle carrier respectively one electromechanical functional module with respectively one electrical energy converter machine is arranged in the drop region, wherein each electrical energy converter machine is connected to the respective wheel flange for transmitting a rotary motion between the energy converter machine and a wheel flange of another wheel hub assembly.

29. The rigid axle as recited in claim 28, wherein each of the electrical energy converter machines is capable of being operated independently of the operating state of the respective other electrical energy converter machine.

30. The rigid axle as recited in claim 29, wherein the axle body is mirror-symmetrical with respect to its axial center and/or that one of the electromechanical functional modules is transferable into the respective other electromechanical functional module by rotating it through 180° about an axis of symmetry orthogonal to the axial direction of the rigid axle and by translational displacement.

31. The rigid axle as recited in claim 28, wherein the axle body is mirror-symmetrical with respect to its axial center and/or that one of the electromechanical functional modules is transferable into the respective other electromechanical functional module by rotating it through 180° about an axis of symmetry orthogonal to the axial direction of the rigid axle and by translational displacement.

32. The rigid axle as recited in claim 15, wherein it has a control unit electrically connected to the at least one electrical energy converter machine and/or an electrical energy store electrically connected to the at least one electrical energy converter machine.
